(19) United States
(12) Patent Application Publication
(10) Pub. No.: US 2003/0023544 A1
(43) Pub. Date: Jan. 30, 2003

(54) Method and system for affluent retiree advance

(76) Inventor: Gary Chodes, Highland Park, IL (US)

Correspondence Address: Supervisor Patent Prosecution Services, PIPER MARBURY RUDNICK & WOLFE LLP, 1200 Nineteenth Street, N.W., Washington, DC, 20036-2412, US

(21) Appl. No.: 09/910,859

(22) Filed: Jul. 24, 2001

(51) Int. Cl. G06F 17/60

(52) U.S. Cl. 705/38

(57) ABSTRACT

A method and system for beneficiaries of benefits not directly assignable, such as Social Security benefits, to receive lump sum payments, such as loans or advances for these benefits. An analysis is made as to a lump sum amount payable to the participant beneficiary, based on such factors as the amount of the benefit, health and credit history of the participant, participant marital status, current benefit amounts, and anticipated cost of living adjustments to the benefit. Once approved for a lump sum, the participant opens an account in a preselected financial institution, to which the benefits are directed. On a periodic basis, pursuant to participant authorization, the account is swept of funds, which are transferred to a second account not held by the participant, for payment to lenders, service providers, and others entitled to funds. The participant is paid a lump sum in exchange for the directed stream of payments.

### BACKGROUND OF THE INVENTION

1. Field of the Invention

The field of the invention relates to a method and system for collecting and paying in a lump sum future streams of payments that are not directly assignable prior to receipt by the recipient, and, more specifically, to a method and system that allows beneficiaries of benefits or other streams of payments that are not directly assignable prior to receipt by the recipient, such as Social Security benefits, as provided under the Social Security Act, P.L. 74-271 (49 Stat. 620), and its amendments, to exchange a stream of future payments via swept accounts in the beneficiaries' names for a discounted lump sum nonrecourse loan or other advance, thereby avoiding problems with directly assigning such streams of payments prior to receipt by the recipient.

2. Background of the Technology

Many United States citizens over the age of 62, and particularly those over 65, are eligible to receive Social Security benefits and receive these benefits on a monthly basis. The amount of benefits, however, is relatively small for wealthy citizens (e.g., citizens having a net worth greater than $750,000). As a result, these benefits are typically not meaningful to these citizens.

As a general rule, people prefer to receive money owed, such as jury settlements, in a lump sum payment, rather than via payments over time. One reason for this preference is to remove some or all of the mortality risk of loss of the benefits (e.g., the beneficiary is able to receive the benefits only during the beneficiary's lifetime; if the beneficiary dies early, benefits that the beneficiary would have otherwise received may be forfeited). Other examples of preference for lump sum payments include reverse mortgages, lump sum severance arrangements, early 401(k) distributions, and advances against streams of income (e.g., structured settlements, annuities, royalties, commissions, lottery winnings, inheritances and legal settlements). The consumer's logic for making decisions of this kind is not purely based on economics, and is frequently impacted by many factors, including net worth, liquidity, age, health, charitable intent, lifestyle, business and investment opportunities, and current family matters. Retirees, for example, have demonstrated a strong preference to take corporate pension payments in lump sum format. According to a recent study by Hewitt Associates of Lincolnshire, Ill., approximately 95% of retirees at large companies opt for an early retirement lump sum option when available, even though in the majority of the cases the economics of lifetime pension payments are compelling.

In the affluent population, this preference is further demonstrated by the rapid acceptance and growth of the high net worth life settlement (“HNW Settlement”) market. A HNW Settlement allows a wealthy senior who owns a large life insurance policy to receive a cash payment by selling the policy at a discount to its face value, as opposed to waiting for payment of a death benefit to beneficiaries at some unknown time in the future, occurring upon the insured's death. HNW Settlements typically involve discounts to face of 60% to 90%, and settlement companies typically price the product to produce internal rates of return in excess of 15%. The pricing of the HNW Settlement product is considered attractive enough for many wealthy seniors to seek out the product. In 1998, the first full year HNW Settlements were available in the market, industry application volume exceeded $2.8 billion face amount of insurance. It has been estimated that the potential settlement market is in excess of $100 billion. Typical reasons for pursuing HNW Settlements mentioned by policyholders and their advisors include: access to liquidity, desire for different and more appropriate life level of insurance coverage, immediate investment opportunities, inability to forecast one's own life expectancy, estate planning needs, charitable intent, and poor insurance policy performance.

Affluent seniors are highly cognizant of the relatively low historical returns on Social Security. In fact, 78% of affluent Americans would recommend requiring the government to invest Social Security to earn yields comparable to private pension plans.

Overwhelmingly, the affluent view Social Security as a retirement program for those who have contributed to it, as opposed to a need-based entitlement. Research indicates that wealthy seniors often frivolously spend their Social Security payments, which are relatively small compared to their overall income. In fact, many financial advisors ignore Social Security entirely in retirement planning for their clients. It is believed that these factors contribute to affluent seniors' potential interest in exchanging their Social Security payments for a lump sum.

Overall, several factors thus impact these recipients' interest in receiving lump sums in lieu of periodic Social Security payments, including: 1) many citizens in the relevant age group, who were born or grew up during the Depression, have a general lack of trust in government; 2) these citizens generally believe that, regardless of their wealth, they deserve what they were promised when they made their contributions to the system; and 3) Social Security provides a poor return on money put into the system.

There is therefore an unmet need to provide such Social Security benefits to wealthy citizens as an immediately collected lump sum payment. There is a technical problem, however, in that Social Security benefits are not legally assignable. For example, citizens eligible for Social Security benefits cannot assign the right to these benefits to a creditor in lieu of payment to that creditor. Federal law prohibits such assignment of benefits (including other benefits in addition to Social Security, such as Medicare or Medicaid payments); these benefits must be received directly by the eligible citizen.

Social Security benefits, in general, are provided as follows. Social Security benefits are paid to retired workers upon reaching retirement age (early, normal, or delayed) on a monthly basis for the remainder of their lives. The amount of such payment is principally based on the worker's lifetime earnings, but is capped (known as the Maximum Social Security Benefit), once a pre-determined cumulative lifetime earnings level has been reached. In addition, upon reaching retirement age, the spouse of a retired worker is entitled to a Spousal Benefit (50% of the retiree's benefit) or the spouse's own benefit (based on lifetime earnings), whichever is higher, payable for the remainder of the spouse's life. The survivor (e.g., widow) of a retired worker receives a survivorship benefit for the survivor's remaining years. Exact benefit levels are determined by formula by the Social Security Administration (SSA).

The existing process for typical direct deposit of benefits for a beneficiary of Social Security is illustrated in FIG. 1. As shown in FIG. 1, a beneficiary 1 transmits 2 to SSA 3 information needed to direct deposit monthly Social Security payments in the bank account 6 of the beneficiary 1. SSA 3 notifies 4 the beneficiary 1 that the beneficiary 1 will begin receiving benefits and requests bank account information for direct deposit. SSA 3 then begins direct depositing 5 benefits in the bank account 6 for the beneficiary 1.

### SUMMARY OF THE INVENTION

The present invention provides a method and system for allowing beneficiaries of benefits or other streams of payments that are not directly assignable, such as Social Security benefits, to receive lump sum payments, such as in the form of non-recourse loans or other advances for these streams of payments. While the term “benefits” is used throughout or interchangeably with “stream of payments” or “streams of payments,” the present invention is no intended to be limited to a particular type of benefit, instead being applicable to any stream of payments or benefits, particularly those that are not directly assignable.

To accomplish the exchange of the benefits or other stream of payments for the lump sum amount, in an embodiment of the present invention, an analysis is made as to a proposed lump sum amount payable to the participant beneficiary, based on such factors as the amount of the benefit, the health of the participant, the participant's age and life expectancy, the participant's marital status, credit and other financial information relating to the participant, and anticipated cost of living adjustments (COLAs) to the benefit. Once approved for a lump sum, the participant opens an account in a preselected bank (e.g., a bank selected by a host entity for the method and system), and provides instructions to the provider of the benefit or other stream of payment, such as the Social Security Administration (SSA) to direct deposit the stream of payments in the participant account. On a periodic basis, pursuant to participant authorization, the account is swept of funds, which are transferred to a second account not held by the participant, for payment to lenders, service providers, and others entitled to funds. As a result, the participant is effectively paid the lump sum in exchange for the directed stream of payments.

The present invention therefore allows a participant (also referred to as a “beneficiary”) to remove the mortality risk with regard to Social Security benefits, or other streams of payment that are not directly assignable, by receiving a lump sum in exchange for these streams of payment. As this lump sum is, for example, provided as a non-recourse loan or other advance, if the participant dies before the participant has paid back this loan or advance, the participant is not liable for repayment. One advantage of this approach is that the participant receives an upfront advance regardless of whether the participant dies before receiving all of the stream of payment to which the participant would have been entitled.

In particular, in an embodiment of the present invention, the lump sum payment is in the form of a limited recourse loan or advance known as an Affluent Retiree Advance (ARA). Since such benefits as Social Security cannot be directly assigned legally, the present invention provides for establishment of a permanent direct-deposit sweep account or other account allowing periodic transfer of funds to effectively facilitate repayment of the non-recourse loan or advance (to a “host entity”) via all of the borrower's benefit proceeds after they are received, in order to pay debt service. In an embodiment of the present invention, the host entity enters into an agreement with a financial institution, such as a bank, a thrift, a brokerage firm, a credit union, a currency change, or, for example, a subsidiary or affiliate thereof, that is able to accept deposits, to establish and maintain these accounts, as well as service the loan portfolio.

To be eligible for an ARA loan or advance, in an embodiment of the present invention, the Primary Borrower needs to be a current recipient of the benefit, such as Social Security, or other stream of payment. The ARA loan or advance amount and commensurate available term is determined based on the Primary Borrower's age, health, expected future benefits or streams of payment, marital status, and (if married) the spouse's age, health, life expectancy, credit and other financial information for the Primary Borrower, and expected benefits. The typical Primary Borrower (participant) is a male head of household, with a living spouse close to his age (the “Secondary Borrower”). In an embodiment of the present invention, any living spouse would typically be party to the transaction for the loan or advance. Because the Borrowers' household is affluent, it is likely that the Primary Borrower had steady Maximum Earnings during working years, and is entitled to benefits at or near the Maximum Social Security Benefit, as defined by SSA.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 is a pictogram illustrating existing direct deposit for non-assignable benefits or streams of payment, such as social security benefits or defined benefit pension payments, for a beneficiary;

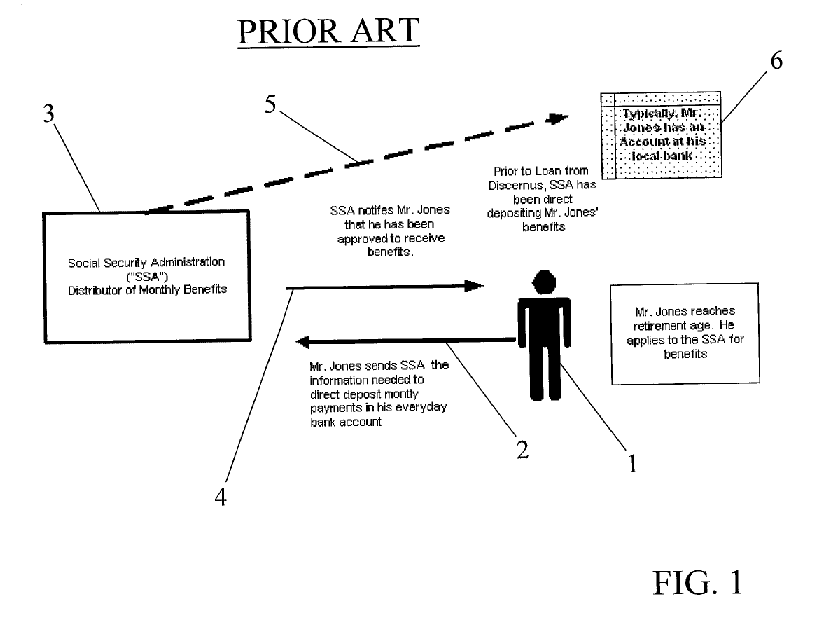

FIG. 2 presents a pictogram of a method and system for providing a lump sum, such as a non-recourse loan or advance, in exchange for a stream of payments that are not directly assignable, in accordance with an embodiment of the present invention;

FIG. 3 shows a flow diagram of a method of providing a lump sum, such as a non-recourse loan or advance, to a participant in exchange for a stream of payments that are not directly assignable, in accordance with an embodiment of the present invention;

FIG. 4 is a flow diagram of a method for determining a lump sum, such as a non-recourse loan or advance, for a participant in exchange for a stream of payments that are not directly assignable, in accordance with an embodiment of the present invention; and

FIG. 5 shows system components for an embodiment of the present invention.

### DETAILED DESCRIPTION

Advantages of a lump sum payment, such as an ARA loan or advance, in accordance with the present invention, include the following: 1) eliminating uncertainty of life expectancy; 2) mitigating uncertainty over future changes to Social Security benefits or other streams of payments; 3) enhancing alternative investment and savings options; 4) expanding estate planning opportunities; 5) transferring wealth to family members; 6) providing alternatives to low returns currently produced by Social Security; and 7) increasing charitable giving.

Further, it is clear that such lump sum payment is likely to be attractive particularly to participants because the advance is generally non-recourse (except under certain circumstances, such as the recipient fraudulently obtaining the loan, which results in the loan being a recourse loan; or in other defined events, such as both spouses dying within the first few years of the loan), and thus the sole source of repayment will be from future direct deposits of Social Security benefits or other streams of payments. Each participant will not incur additional direct personal (e.g., recourse) debt, which, if it existed, could be perceived as unattractive to certain wealthy retirees. In addition, if proceeds from the ARA loan or advance are used for investment purposes, the interest expense on the advance may be partially or fully used to reduce taxes by offsetting investment interest income (for certain types of investment income).

The following example in accordance with an embodiment of the present invention describes a scenario for a typical participant in the method and system of the present invention. In this example, the participant is an older, HNW individual who, for example, works with a financial advisor, a financial planner, or an estate planner. (The participant may also participate individually, without the assistance of an advisor.) Other advisors for the participant could include, for example, insurance agents, insurance advisors, lawyers, certified public accountants, or brokers. This adviser brings up to the participant the idea of obtaining a nonrecourse course as an advance on the participant's Social Security benefits or other streams of payments. The advisor makes this suggestion to the participant partly because the participant does not depend on Social Security for basic living needs. The participant has substantial savings, and, in proportion to the participant's overall wealth and income, Social Security is not that meaningful.

One reason that Social Security is not very meaningful to possible participants in the present invention, such as the participant in this example, is that the participant is only obtaining a small amount of money from Social Security relative to wealth; the smaller the relative amount, the less meaningful it is to the participant. By providing the opportunity for such situated participants to obtain benefits or other streams of payments as lump sums, these participants typically view the lump sums as benefits of value.

On the protection side, the intent of Social Security is to ensure that recipients have a “safety net,” and one concern of the government is that, even though recipients of Social Security could benefit from a lump sum, it is generally in these recipients' better interest to receive money on a month-to-month basis so that these benefits can meet their on-going basic living expenses.

To participate, the participant completes an application, and in conjunction with the application, the participant signs a release, as explained further below. The financial advisor returns the application to a host entity for the present invention, in one embodiment for which the host entity is referred to as “Discernus,” along with the release. The release allows the host entity to receive personal information on the participant, such as, but not limited to, the participant's credit history and health history.

Once the host entity receives all of the participant's information and confirms that the participant is a current beneficiary or is eligible as a beneficiary, such as for Social Security benefits or a pension, the host entity determines if the risk of making an advance to the participant will produce an adequate expected return, given underwriting criteria applied to the participant. In one example embodiment, the host entity considers making loans or advances for a term of between seven and ten years. In making this determination, in this embodiment, an examination and analysis is made of the participant's health and age, including, for example, comparing the participant's age to actuarial tables to ensure that the participant is likely to outlive the length of the loan or advance. For example, if the participant is a normal 65 year old, it is likely that the participant will outlive a ten year loan or advance.

Consideration is next made of any specific issues that relate to the participant's health. For example, if the participant is a smoker, this may affect the participant's risk, as would other serious health issues, such as a history of heart attacks or other health conditions that can potentially shorten the life of the participant. In addition, confirmation is made that the participant's present financial history is good. Even though, for example, the participant is relatively affluent and has been paying bills on time, there should be assurances that the participant does not have large debts outstanding that the participant did not reveal in the application or have any prior history of bankruptcy. Typically, this analysis includes obtaining a credit score for the participant. Assuming that the participant meets all of the criteria, a determination is made that a loan or advance can be made to the participant.

The next issue to be addressed is the the potential size of the loan or advance that may be made. The size of the loan or advance is dependent, at least partially, upon five factors: 1) the amount of benefit or other stream of payment, such as Social Security, that the participant receives; 2) the length of time for which the loan or advance is requested; (3) factors and mechanisms relating to the benefit or stream of payment system, including, for example, Social Security COLAs; 4) the interest rate to be charged on the loan or advance; and (5) life expectancy.

One important variable for pricing the ARA product effectively, for example, is reasonably accurate information about the expected future Social Security Benefits over the collective lifetimes' of the participants. A participant's current Social Security benefit is known and certain at the time of the ARA advance application. The pricing model of the present invention reflects future changes to benefit amounts resulting from annual COLAs, risk of mortality, and changes to retirement status. The model is highly flexible and, in an embodiment of the present invention, easily interfaces with existing SSA benefit calculation software and other inputs from retirees' benefit statements.

Further, developing accurate life expectancy estimates based on current information about each participant is critical. To forecast the participant's life expectancy in a conservative manner, proprietary mortality tables are used that incorporate age, gender, and smoker status as inputs. The expected demographics of the typical ARA participant are evaluated, including age, net worth, lifestyle, and propensity to maintain health. Based partly on the results of analysis of a multitude of mortality-related products (for example, actuarial studies, review of life insurance and pension mortality experience), the present invention predicts that the typical ARA participant will live longer than the average Social Security recipient, all other things being equal. Nonetheless, the tables developed for the present invention are generally conservative (i.e., project shorter lives) relative to those used by SSA, as well as those used by insurance companies that primarily sell mortality-based products, such as life insurance and annuities.

In an embodiment of the present invention, the host entity directly underwrites each case by obtaining medical information about the participant, including both the Primary (participant) and Secondary Borrower (spouse), assuming the participant has a spouse. Participants are rejected if they have significantly deteriorating health that would most likely dramatically reduce life expectancies. In an embodiment of the present invention, a team of skilled underwriting professionals utilizes underwriting data to make appropriate adjustments to the base mortality tables in a manner similar to that employed in underwriting life insurance or HNW Settlements.

In an embodiment of the present invention, the amount of advance to a particular participant is adjusted to achieve a targeted rate of return over the term of the loan or advance. The loan or advance is structured so that it is fully amortized well before the participants' joint life expectancy (assuming a participant and spouse) (unless structured with a recourse balloon payment for non-amortized principal). The host entity typically earns most of its expected return on an ARA advance in the first eight years of the loan or advance.

Participant related factors that potentially impact the amount of the loan or advance include the following: 1) age, health, and life expectancy of the participant; 2) earnings history of the participant; 3) marital status; 4) one or both spouse(s)'s benefits (or stream of payments) used; 5) amount of benefit(s); 6) expected future earnings of participant; and 7) early, normal or delayed retirement. Company/market factors (typically determined by the host entity) that potentially impact the amount of the loan or advance include: 1) target rate of return; 2) overhead and direct cost assumptions; 3) borrowing costs and leverage; 4) future inflation and COLA assumptions; 5) portfolio credit loss experience; and 6) portfolio fraud loss experience.

The impact of inherent benefit or other stream of payment specific factors, such as COLAs for Social Security, are illustrated by the following example. COLAs, in the recent past, have typically resulted in benefits rising between 2% and 3% or higher per year, dependent somewhat upon the will of Congress. These COLAs supposedly are meant to compensate the beneficiaries for inflation in the economy. With regard to the example for the participant discussed above, the COLAs are considered as follows. If the participant is to receive $1,000 for fiscal 2002, and in the following year Congress sets the COLA as 2%, the participant will receive $1,020 in 2003. Such anticipated changes in received benefits are addressed as loan or advance size and time length considerations. The participant may expect to receive significantly greater benefits 10 years from the beginning of the term of the loan or advance. Calculation of the loan or advance amount is made, for example, using a net present value that discounts the stream of cash flows over the period of the loan or advance, varying by the size of the loan or advance, at the interest rate that the host entity uses.

As suggested above, another factor considered by the present invention is whether the participant has a spouse. The target group of Social Security beneficiaries for participation in the present invention includes a high proportion of married couples. By considering the spouse of the participant with the participant, both the participant's and the participant's spouse's benefits (e.g., spouses direct benefit; spouse's widow benefit) may be considered together in the loan or advance amount. A number of other factors impact benefits for the participant and spouse together. For example, if the male spouse typically has been the primary wage earner, that spouse will therefore receive greater benefits than the female spouse, but the female spouse will generally be entitled to additional survivor (i.e., widow) benefits upon the death of the male spouse. While survivor benefits may be typically less than living benefits for the male spouse, each of these factors is incorporable into the calculation of the loan or advance that is made in accordance with the present invention.

In summary, a number of factors are usable in calculating the loan or advance to a participant. These factors include the following: 1) the size of the participant and the participant's spouse's total benefit or other stream of payments; 2) the maturity of the loan or advance; 3) the assumed interest rate by the host entity; and 4) the predicted COLAs or other stream of payment specific adjustments.

Once a loan or advance size is calculated, the host entity typically offers the loan or advance through, for example, a financial planner, an estate planner, an insurance agent, an insurance advisor, a lawyer, a certified public accountant, or a broker. The loan or advance may also be offered directly to the participant. If the loan offer or advance is accepted by the participant, the participant opens a new account in the participant's name at a bank selected by the host entity or agreed upon by the parties, and the participant arranges for the participant's benefits to be directly deposited into this new account. Typically, so as to minimize the costs of this new account (also referred to as “the participant account”), the participant account is, for example, a regular, non-interest bearing checking account, although other types of accounts or other financial products may be used to hold proceeds (e.g., benefits). The selection of the participant account of a type that is as inexpensive, in terms of fees, as possible, and that typically earns no interest, is logical in that any funds deposited into the participant account are typically present only a few hours, days, or weeks, such that little or no interest would otherwise accrue in the account.

The participant also provides instructions to the selected bank in which the participant account is opened, to the effect that the bank is to withdraw or otherwise transfer funds from the participant account (“sweep the account”) upon the deposit of these funds from, for example, SSA, or otherwise on a regular basis, and to transfer some proportion of these withdrawn funds to one or more other accounts (the “second account”), as specified by the host entity. Once the participant has opened the participant account and the sweep or other transfer instructions have been received by the bank, the host entity advances to the participant a lump sum, such as a non-recourse loan or advance in the agreed amount, typically less a commission paid to a financial planner for the participant.

The participant is now free to use the money advanced by the host entity in the manner the participant chooses.

In operation, the benefit provider, such as SSA, begins sending the participant's payments to the participant account, typically through direct deposit at the financial institution that the host entity has specified. The participant account is swept or otherwise transferred on a regular basis, such as daily or weekly, and any money in the participant account is transferred to a second account specified by the host entity.

In an embodiment of the present invention, the second account is often a special type, referred to as a “bankruptcy remote” account, which isolates the ARA loans from the general creditors of the host entity, vastly enhancing the status of the securitization lenders in the event that the host entity becomes bankrupt. Such accounts generally enhance creditors' interest in making loans or advances. These creditors, for example, include lenders from whom the host entity has borrowed money to make loans or advances, in turn, to participants.

The second account uses the received money from participants' accounts to service the debt on these loans or advances. The received money is used first to pay the interest on the loan or advance and then to pay the principle on the loan or advance. The bank at which the second account is located withdraws service fees from the account, and the remainder is then sent to a third account, such as a regular checking account held by the host entity.

Further examples and features of the bankruptcy remote account, in accordance with embodiments of the present invention, are as follows.

The bankruptcy remote account can be in the form of a trust, on behalf of various entities, such as the following: 1) an affiliate of the host entity; 2) a lending institution, such as a bank, from which the host entity borrows money to provide an ARA; or 3) a lender, such as a commercial paper conduit, from which the host entity borrows money to provide the ARA. In some of these embodiments of the present invention, the host entity securitizes the ARA loan. In other embodiments, the host entity “sells” a portfolio of loans or advances in a whole loan or advance sale to a financing entity, which includes various types of financial institutions, including subsidiaries or affiliates thereof, that are able to lend the host entity money to make the loans or advances. In this event, the sale price is typically slightly less than 100% of the value of the loan or advance (e.g., between 90% and 99%). Thus, the financial entity that has provided the host entity with capital now actually owns the loan or advance—it is on the financial entity's balance sheet as an asset.

In other embodiments, the host entity does not securitize the loan or advance. Instead, the host entity retains the loan or advance on its own books as an asset. In these embodiments, the host entity is able to pledge the loan or advance portfolio as collateral received from the financing entity. In one embodiment of the present invention, such retained loans or advances are transferred to an affiliate of the host entity. As proceeds toward repayment of the loan or advance are received, the value of the loan or advance is reduced.

Regardless of the type of trust or other mechanism that is selected, embodiments of the present invention, in accordance with the present example, typically there are at least three other third party roles other than those performed by the financial institution, the financing entity, and the host entity, or subsidiary or affiliate thereof, that ensure payments from the participant accounts are made to the proper parties. The most typical third party roles include a Trustee, a Servicer, and a Custodian. In some embodiments of the present invention, the same company (which could be the financial institution or financing entity) performs the third party roles. In other embodiments, different companies perform certain functions. In addition, the host entity can perform most or some aspects of the third party roles.

With all of these embodiments, the Trustee and Servicer roles involve different responsibilities. The Servicer functions as an administrative entity responsible for making payments, tracking loan or advance balances, calculating payment amounts and loan or advance balances, facilitating payoffs or prepayments, calculating interest expense per loan or advance, and overseeing collection activities. The Trustee, as in any trustee role, ensures that the money received is paid to proper entities in the proper order, as determined, for example, by loan or advance documents between the host entity and the financial institution from which the host entity is borrowing.

For example, in accordance with an embodiment of the present invention, the host entity receives money from a Commercial Paper Conduit. In some embodiments, the money is borrowed via a special purpose vehicle (“SPV”), such as a specialized corporation established and organized under the laws of Delaware. The single purpose of the SPV in this example is to issue commercial paper to investors and to use the proceeds to purchase assets from a seller or multiple sellers. Embodiments of the present invention use a multi-seller SPV. In one example in accordance with these embodiments, a lending institution sets up an SPV that issues commercial paper. When the SPV issues the paper, the SPV buys the corresponding loan or advance from the host entity at a discount. The SPV in this embodiment is referred to as the “Sponsor” or a “Conduit Purchaser.”

The host entity receives money from the Sponsor and advances money to the participant. In this example, immediately prior to receiving the loan or advance, the participant sets up an account at the Servicer's financial institution, in the participant's name. The account is used solely for the purpose of receiving the participant's non-assignable benefits, such as Social Security payments. However, the participant provides the Servicer with the right, through written instructions to, “sweep” or otherwise transfer proceeds from the account.

Money received into the account is then transferred to the second account, such as an account in the name of the host entity. The second account also includes access privileges for or obligations to the Servicer, the Trustee (in this example, the Servicer and the Trustee are the same entity), and an Administrative Agent. (In some embodiments of the present invention, the Servicer is the company that sells the product (e.g., the host entity).) Upon receiving the money, the Servicer applies the money received, as follows: 1) servicing fee (assumes Servicer is not the seller); 2) payment to reduce the principal and interest on the ARA loan or advance; 3) payment of the custodian fee and the Trustee fee; 4) a Purchase Premium—a premium payment at a percentage over the rate that the conduit issues the commercial paper, to compensate for the risk of accepting the assets in the Conduit; 5) a Purchase Discount—an interest rate amount, usually based off of London Interbank Offered Rate (LIBOR) plus some amount; Note: items 4 and 5 are based on the average cash investment outstanding by the Conduit); and 6) a payment for the unused fee (a small percent on the difference between the total amount that is available to the seller and the actual amount used). While this order of payment is common to some embodiments, payment in other than the order above is also usable in accordance with the present invention.

With regard to the participant account, the entity in which the account is placed does not necessarily have to be a Trustee. In some embodiments, the entity is directly “related” to the host entity, and in other embodiments, there are several intervening entities between the account holder and the host entity. Regardless of the type of entities involved and the relationships among the entities, one purpose of the entities is to provide a mechanism for segregating the cash flow funds related to the ARA loan or advance (e.g., Social Security benefits) from other assets and liabilities of the host entity. Further, cash flow among the entities may occur, for example, on behalf of individuals who have lent funds to be used for loans or advances to the participants, either in the form of equity or debt.

References will now be made in detail to embodiments of the present invention, examples of which are illustrated in the accompanying drawings.

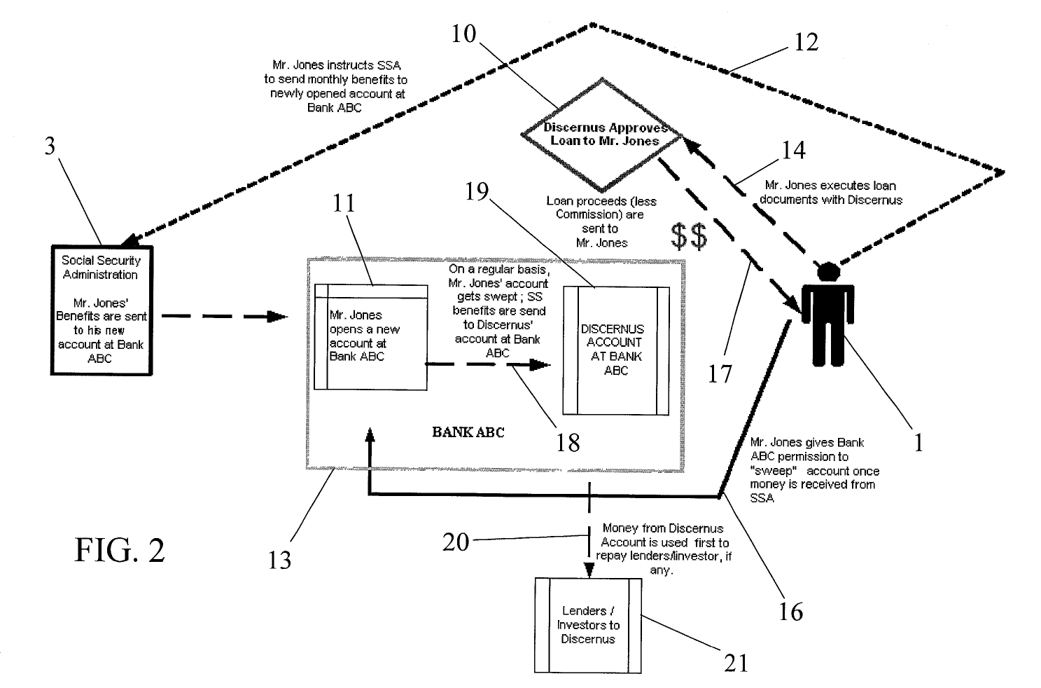

FIG. 2 presents a pictogram of a method and system for providing a lump sum benefit, such as a non-recourse loan or advance, in exchange for a stream of non-assignable benefits, in accordance with an embodiment of the present invention. As shown in FIG. 2, a participant 1 is approved by a host provider 10 for a lump sum benefit, such as a non-recourse loan or advance. The participant 1 instructs 12 the SSA 3 to send benefits to a newly opened account 11 in a bank or other financial institution 13. Concurrently with opening the account 11, the participant 1 executes loan documents and sends the executed documents 14 to the host provider 10. The account 11 is referred to as a “bankruptcy remote” account. The participant 1 then provides 16 the financial institution 13 with permission to sweep or otherwise transfer proceeds from the account 11 once money is received in the account 11 from SSA 3. The loan or advance proceeds, less a commission are sent 17 to the participant 1 from the host provider 10.

The SSA 3 periodically sends the benefits to the account 11. On a periodic basis, such as weekly or monthly, or at some periodic interval, such as the next day, following receipt of the benefits in the account 11, the account 11 is swept and proceeds in the account 11 are transferred 18 to a second account 19, such as an account in the name of the host entity 10. Proceeds from the second account 19 are used 20 first to repay lenders 21 to the host entity 10.

One feature of the present invention includes various software applications that provide end-to-end management for application and loan or advance processing. The systems and software are designed to efficiently manage the business. This software includes the following features: 1) a scalable platform that cost-effectively processes the projected volume of loans and/or advances without the need for substantial investments in additional technology in the future; 2) collects, monitors, and integrates information, allowing production of timely, accurate, and analytical reports to assist in operating the business and to allow proactive planning for the future; this feature also includes organizing hardware and databases so that information is readily accessible and easily configurable to meet the needs of various users; 3) provides consistent and reliable customer service, allowing advisors to easily conduct business with the host entity; the system allows the host entity to quickly resolve any issues or problems that may arise and ensure uninterrupted quality service to advisors.

The software applications of the present invention are structured around the four distinct phases of the life cycle of the product, including the following: 1) origination— including initial application review and credit screening, marketing, sales, and prospecting (through a Customer Relationship Management (CRM) approach); 2) application processing—all phases, including application tracking, underwriting, loan or advance documentation, commission payments, and loan or advance closing; 3) servicing—all post-closing activities, such as loan and advance servicing, loan and advance reporting, customer tracking and monitoring, loan and advance collection, and interface with the financial institution; 4) support including corporate administration, interface with the host entity's accounting and financial reporting, loan and advance performance review, and customer and advisor profitability analysis.

The systems of the present invention are designed to support the entire enterprise and its strategy in bringing the product to market. Although the ARA loan or advance is the primary product using the system in one embodiment of the present invention, the platform is constructed such that additional products are offerable through a similar distribution channel. One of the major potential benefits of a CRM-based approach is that it facilitates cross-selling opportunities. The objectives of cross-selling are to increase the number of products purchased by HNW consumers, as well as the number sold by advisors. For example, advisors are able to be notified automatically upon certain transactional events, which may be indicators of the propensity for the consumer to buy additional products and services.

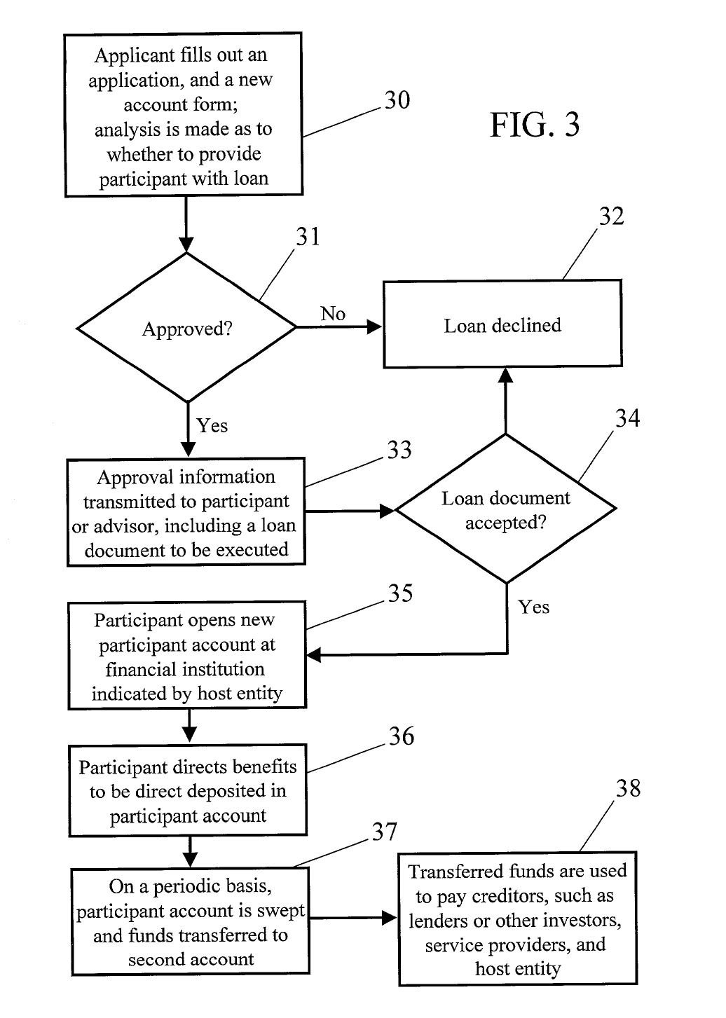

FIG. 3 shows a flow diagram of a method of providing a lump sum benefit, such as a non-recourse loan or advance, to a beneficiary in exchange for a stream of non-assignable benefits, in accordance with an embodiment of the present invention. As shown in FIG. 3, a potential participant fills out an application and completes a bank account form; analysis is first made as to whether to provide a participant with a lump sum, such as a non-recourse loan or advance 30. The lump sum is then approved or disapproved 31. If disapproved, the participant is declined for receipt of the lump sum 32. If approved, approval information is transmitted to the participant or the participant's advisor, along with a loan document for execution 33. The loan document is then accepted or declined 34. If the loan document is declined, the participant is declined for receipt of the lump sum 32.

If the loan document is approved, the participant opens a new participant account at a financial institution indicated by the host entity 35. The participant directs that the benefits, such as Social Security, to be deposited into the participant account 36. On a periodic basis, the participant account is swept, and funds are transferred to a second account, such as an account held by the host entity 37. Funds transferred to the second account are then used to pay obligations, such as loan or advance creditors, service providers, and the host entity 38.

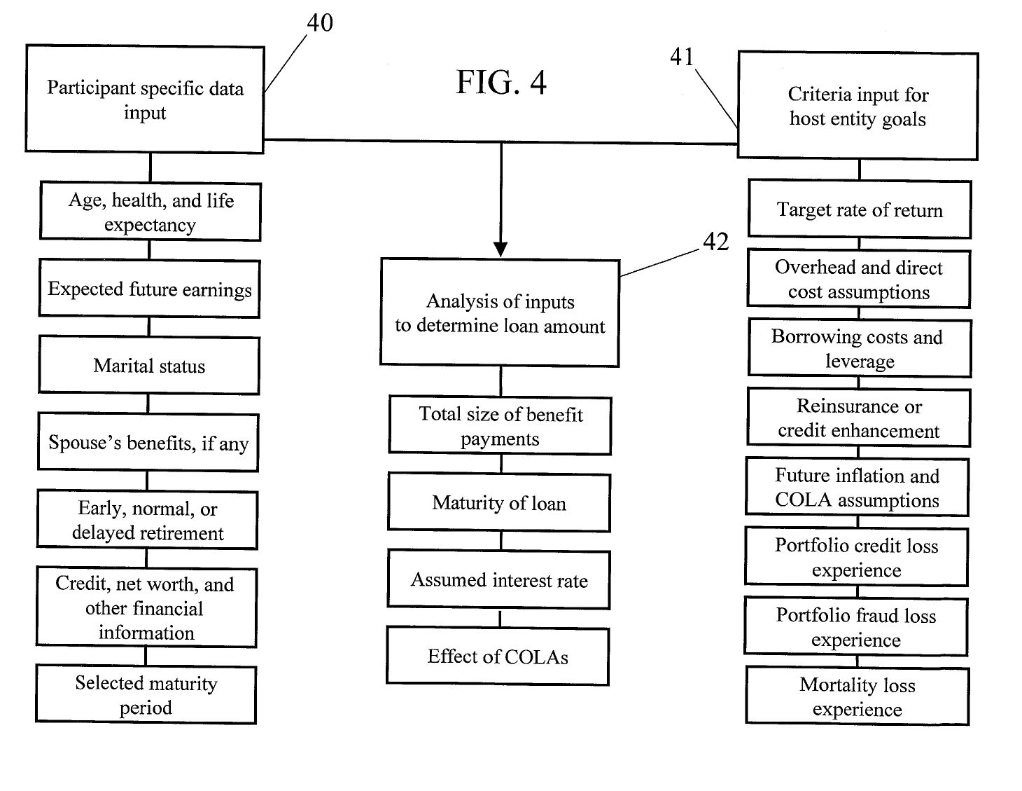

FIG. 4 is a flow diagram of a method for determining a lump sum benefit, such as a non-recourse loan or advance, for a beneficiary in exchange for a stream of non-assignable benefits, in accordance with an embodiment of the present invention. As shown in FIG. 4, participant related factors that potentially impact the amount of the loan or advance 40 include the following: 1) age, health, and life expectancy of the participant; 2) earnings history of the participant; 3) marital status; 4) one or both spouse(s)'s benefits used; 5) early, normal or delayed retirement; 6) credit, net worth, and other financial information; and 7) selected maturity period. Criteria used in making a determination by, for example, the host entity 41 that potentially impact the amount of the loan or advance include: 1) target rate of return; 2) overhead and direct cost assumptions; 3) borrowing costs and leverage; 4) reinsurance or credit enhancement; 5) future inflation and COLA assumptions; 6) portfolio credit loss experience; 7) portfolio fraud loss experience; and 8) mortality loss experience. The participant specific data inputs 40 and the criteria input for host entity goals 41 provide inputs for an analysis to determine the loan or advance amount 42. Analysis 42 includes application of the following: 1) the size of the participant and the participant's spouse's total benefit payments; 2) the maturity of the loan or advance; 3) the assumed interest rate by the host entity; and 4) the predicted COLAs or other benefit specific adjustments.

Embodiments of the present invention also include the following additional features:

1) Internal Application Processing—This feature allows efficient ARA loan or advance application and processing. A portion of this feature includes electronic interfaces with multiple third parties, such as the financial institution and providers of underwriting information.

2) Intranet—An embodiment of the present invention includes a dedicated intranet site providing financial advisors with information supporting their selling efforts. Using this site, advisors are able to determine the status of their customers' applications, loans and advances, and commission payments. In addition, the site includes specific content and financial tools that assist the advisor in selling the ARA loan or advance and subsequent investment products.

3) Direct Customer Access to Account Information.

4) Support Feature for Servicing Asset Portfolios Originated by Third-Party Lenders.

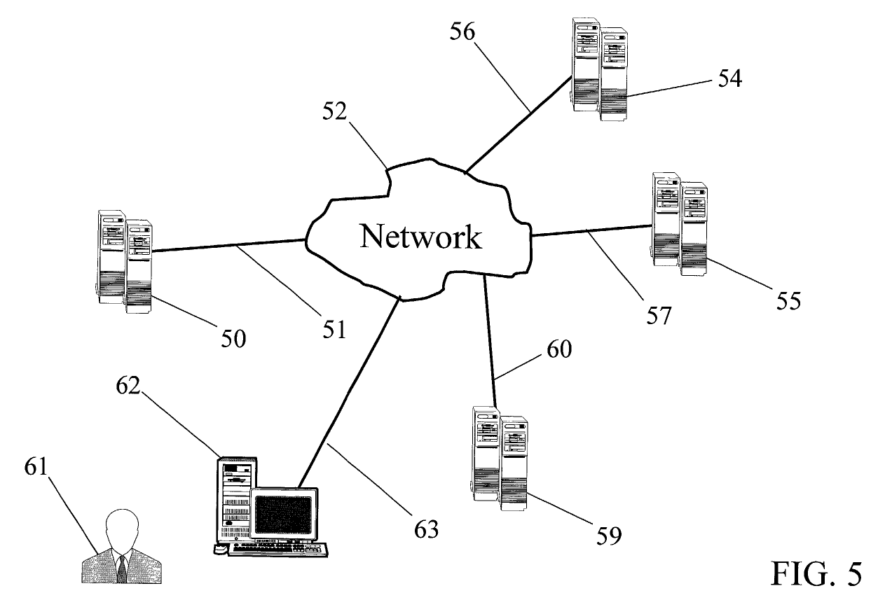

FIG. 5 shows system components for an embodiment of the present invention. As shown in FIG. 5, a first server 50 (the “lump sum processing server”) provides internal application processing, such as ARA application and loan or advance processing. The first server 50 is coupled 51 to a network 52, such as an intranet or the Internet. The coupling 51 includes, for example, wired, wireless, or fiberoptic links. The server 50 includes a processor, such as a minicomputer, microcomputer, main frame computer, or personal computer (PC), and, optionally, a repository, such as a database, or coupling to a database. Servers 54, 55 provide interface with third parties, such as financial institutions and providers of underwriting information. In addition, optionally, a separate server 59 via coupling 60 provides access via the network 52, such as to provide access for users 61, such as financial advisors or customers directly accessing information, via a terminal 62 and coupling 63. The terminal 62 includes, for example, a PC, minicomputer, microcomputer, main frame computer, telephone device, hand held wireless device, or other device with a processor and display.

Another advantage of the present invention is that it provides an ARA lump sum advance against either Social Security or Defined Benefit (DB) Pension Assets, which potentially provides a funding mechanism for the purchase of a new financial product by the participant. Life insurance sales are expected to generate the single largest category of ARA-funded products for the advisor recommending the present invention to a participant, as such benefits as Social Security and DB pension plans generally provide no meaningful death benefit, and are subject to significant benefit reductions and/or elimination upon the death of the participant or spouse.

Further, Social Security and pension fund investment criteria are predetermined and outside the participant's control. In general, historical returns for Social Security have been dismal, and most DB pension plans have been historically conservative in their investments. Neither provide the ability for the individual to direct assets, make investment choices, adjust asset allocations, or change distribution formulas over time. Inflation protection in future years may also be inadequate. Variable universal life and universal life insurance can address many of these issues. For these reasons, and because of some participants' need for large death benefits, life insurance is an ideal purchase with ARA loan or advance proceeds. The policy's large death benefit in some cases provides the necessary liquidity to fund estate taxes, facilitate succession planning for a business (many affluent retirees still own a business), or fund other estate planning needs. Cash value from a policy can be borrowed at any time for current needs.

For example, if a married couple (male 67 and female 65) in good health receiving maximum Social Security benefits received an ARA advance of approximately $180,000, they are able to use that lump sum to fund approximately $4.5 million of face amount survivorship universal life insurance coverage paid up for approximately 20 years (i.e., the policy is not projected to require additional premium payments during that time period). This represents a sharp contrast to their current $2,700 monthly Social Security payments that many retirees currently spend or “waste.”

Another potentially excellent use of ARA proceeds is for the purchase of variable (deferred) annuities. Variable annuities are popular with HNW individuals in their 60's who are looking to accumulate funds on a tax-deferred basis. Many participants in the present invention are anticipated to be accumulating wealth for many years to come. Further, some still have at least one family member working full time, and many continue to own a business. These facts further support the participant deferring income, making variable annuities attractive. Furthermore, variable annuities allow broad investment management choices, but also provide downside protection with a guaranteed minimum return of principal and often a minimum return or bonuses at the time of an annuitant's death.

A number of other complementary products or features are also usable with the present invention, thereby enhancing the value of the present invention. These complementary products and uses include the following:

Combining and cross-collateralizing the ARA loan or advance with other assets (home, existing life insurance) to provide larger and more flexible loans or advances. The present invention allows participants to value and receive loans or advances combining non-traditional assets (e.g., Social Security and DB pension payments) with other more traditional assets, such as life insurance cash value, 401(k) balances, and home equity. For example, the Social Security and DB pension payments of retired couples may be combined into a single account, providing a “Jumbo” ARA. Other assets are addable as security to an ARA to provide even larger loans or advances.

Providing liquidity to the client against other illiquid financial assets. Like Social Security and DB Pension assets, other significant assets of the affluent are often illiquid and thus provide a unique opportunity for host entities to advance funding to clients and earn attractive returns. This includes HNW settlements (life insurance), advances against deferred compensation, and loans or advances to facilitate the conversion of vested options or qualified Employee Stock Ownership Plan (ESOP) assets.

Providing financing where the collateral is strong but loan- or advance-to-values are traditionally low. In certain circumstances, conventional lending criteria may limit loan- or advance-to-values and advance rates in arbitrary or inappropriate ways for wealthy clients. These include third-party loans, advances, and/or lines of credit against 401(k) assets (generally 50% limit) and other qualified retirement assets, jumbo reverse mortgages (traditional Federal National Mortgage Association (FNMA) reverse mortgages are capped at approximately $200,000), and loans or advances against cash value in life insurance. Traditional lenders have not focused on these assets, often because of their lack of familiarity with life insurance, inexperience with the mortality, move-out and cash flow characteristics of reverse mortgages, and lack of a natural distribution network to access qualified retirement assets. Further, traditional lenders have incorrectly assumed that other types of financial institutions provide market-driven products for their clients (e.g., insurance companies with respect to 401 (k)'s and cash value loans or advances; FNMA with respect to reverse mortgages). This lack of focus by major financial institutions allows participants to use the present invention to obtain loan or advance and line of credit products with above market returns.

Example embodiments of the present invention have now been described in accordance with the above advantages. It will be appreciated that these examples are merely illustrative of the invention. Many variations and modifications will be apparent to those skilled in the art.

What is claimed is:

1. A method for providing a participant with a lump sum in exchange for non-directly assignable benefits received by the participant, the method comprising:
determining a value for the lump sum for the participant;
paying the lump sum to the participant;
directing the received benefits to a participant account; and
periodically transferring the received benefits from the participant account to a second account.

2. The method of claim 1, wherein determining a value for the lump sum payment for the participant includes:
inputting participant specific data;
inputting criteria data for return goals; and
analyzing the input participant specific data and the criteria data for return goals.

3. The method of claim 2, wherein the participant specific data includes at least one selected from a group consisting of age, health, life expectancy information, credit, and financial information.

4. The method of claim 2, wherein the participant specific data includes at least one selected from a group consisting of earnings history, expected future earnings, and social security benefit information.

5. The method of claim 2, wherein the participant specific data includes marital status information for the non-directly assignable benefits.

6. The method of claim 2, wherein the participant specific data includes spousal benefits information.

7. The method of claim 6, wherein the spousal benefits information includes one selected from a group consisting of widow benefits information and spousal Social Security benefits information.

8. The method of claim 2, wherein the participant specific data includes retirement information.

9. The method of claim 8, wherein the retirement information includes information relating to one selected from a group consisting of early retirement, normal retirement, and delayed retirement.

10. The method of claim 2, wherein the criteria data for return goals includes at least one selected from a group consisting of target rate of return, overhead and direct cost assumptions, borrowing costs and leverage, reinsurance or credit enhancement, future inflation assumptions, cost of living adjustment assumptions, credit loss experience, fraud loss experience, and mortality loss experience.

11. The method of claim 2, wherein the input participant specific data and the criteria data for return goals include at least one selected from a group consisting of total size of benefit payments, maturity of loan or advance, assumed interest rate, and effect of cost of living adjustments.

12. The method of claim 1, wherein the non-directly assignable benefits comprise Social Security benefits.

13. The method of claim 1, wherein the participant account is a minimum fee account.

14. The method of claim 1, wherein the participant account is a non-interest bearing account.

15. The method of claim 1, wherein the received benefits in the participant account are transferred to the second account daily.

16. The method of claim 1, wherein the received benefits in the participant account are received on a preselected day, and wherein the received benefits in the participant account are transferred to the second account within a predetermined period following preselected day.

17. The method of claim 1, wherein the received benefits in the participant account are transferred weekly.

18. The method of claim 1, wherein the second account is a bankruptcy remote account.

19. The method of claim 1, wherein the second account is held by a provider of the lump sum payment.

20. The method of claim 1, wherein the second account is held by an account provider, the method further comprising:
paying a service fee to the account provider for the second account.

21. The method of claim 20, wherein the service fee is paid from the transferred swept benefits.

22. The method of claim 1, further comprising:
paying a loan payment to a debtor from the second account.

23. The method of claim 1, further comprising:
paying an advance payment to a debtor from the second account.

24. The method of claim 1, further comprising:
paying a fee to at least one service provider from the second account.

25. The method of claim 24, wherein the at least one service provider is one selected from a group consisting of a financial planner, a financial advisor, an estate planner, an insurance agent, an insurance advisor, a lawyer, a certified public accountant, and a broker.

26. The method of claim 24, wherein the at least one service provider is a provider of the lump sum payment.

27. The method of claim 1, wherein the lump sum payment comprises one selected from a group consisting of recourse loan proceeds, limited recourse loan proceeds, and non-recourse loan proceeds.

28. The method of claim 1, wherein the lump sum payment is a non-recourse advance.

29. The method of claim 1, further comprising:
determining whether to approve payment of the lump sum payment to the participant.

30. The method of claim 29, further comprising:
if a determination is made to approve payment of the lump sum payment to the participant, transmitting approval information to the participant.

31. A method for a provider to provide a loan to a participant in exchange for Social Security benefits, the method comprising:
determining a value for the loan;
paying the loan to the participant;
the participant opening a new account;
the participant providing instructions to direct the Social Security benefits to the new account; and
periodically transferring the directed benefits from the new account to a second account, wherein the second account is held by the provider.

32. The method of claim 31, wherein the loan is one selected from a group consisting of a nonrecourse loan, a recourse loan, and a limited recourse loan.

33. The method of claim 31, wherein the loan is one selected from a group consisting of a nonrecourse advance, a recourse advance, and a limited recourse advance.

34. A system for providing a participant with a lump sum in exchange for non-directly assignable benefits received by the participant, the system comprising:
means for determining a value for the lump sum for the participant;
means for paying the lump sum to the participant;
means for directing the received benefits to a participant account; and
means for periodically transferring the received benefits from the participant account to a second account.

35. A system for providing a participant with a lump sum in exchange for non-directly assignable benefits received by the participant, the system comprising:
a lump sum processing server coupled to a network, the lump sum processing server for receiving and analyzing data;
a financial institution server coupled to the network; and
an underwriting server coupled to the network;
wherein the lump sum processing server receives lump sum determination data for the participant, the lump sum determination data including non-directly assignable benefits information; wherein the lump sum processing server transmits the lump sum determination data to the underwriting server; wherein the underwriting server determines risk information for the participant; wherein the underwriting server transmits the risk information to the lump sum processing server; wherein the lump sum processing server determines a value for the lump sum payment; wherein the lump sum payment value information is transmitted to the financial institution server; and wherein payment of the lump sum is made to the participant.
